(19) United States
(12) Patent Application Publication
(10) Pub. No.: US 2026/0010479 A1
(43) Pub. Date: Jan. 8, 2026

(54) TECHNIQUES FOR CHANGELOG MANAGEMENT

(71) Applicant: Micron Technology, Inc., Boise, ID (US)

(72) Inventors: Wenjun Wu, Shanghai (CN); Huachen Li, Shanghai (CN); Xing Wang, Shanghai (CN); Qingyuan Wang, Shanghai (CN)

(21) Appl. No.: 19/238,007

(22) Filed: Jun. 13, 2025

Related U.S. Application Data
(60) Provisional application No. 63/667,635, filed on Jul. 3, 2024.

(51) Int. Cl. G06F 12/0868; G06F 12/02

(52) U.S. Cl. CPC G06F 12/0868; G06F 12/0246; G06F 2212/7201

(57) ABSTRACT

Methods, systems, and devices for techniques for changelog management are described. A memory system may implement a foreground changelog associated with storing new mappings received from a host system and a background changelog associated with storing old mappings received from the foreground changelog. The memory system may be configured to transfer old mappings from the background changelog to a mapping table stored at a volatile memory of the memory system, while new mappings are received at the foreground changelog. Then, the memory system may transfer the new mappings from the foreground changelog to the background changelog based on satisfying a capacity of the foreground changelog. The memory system may update the mapping table with the old mappings each time the background changelog is emptied, and may flush the mapping table to a mapping table stored at a non-volatile memory of the memory system other times the background changelog is emptied.

### CROSS REFERENCE

The present application for patent claims priority to U.S. Patent Application No. 63/667,635 by Wu et al., entitled “TECHNIQUES FOR CHANGELOG MANAGEMENT,” filed Jul. 3, 2024, which is assigned to the assignee hereof, and which is expressly incorporated by reference in its entirety herein.

### TECHNICAL FIELD

The following relates to one or more systems for memory, including techniques for changelog management.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not- or (NOR) and not- and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports techniques for changelog management in accordance with examples as disclosed herein.

FIG. 2 shows an example of a system that supports techniques for changelog management in accordance with examples as disclosed herein.

FIG. 3 shows an example of a process that supports techniques for changelog management in accordance with examples as disclosed herein.

FIG. 4 shows a block diagram of a memory system that supports techniques for changelog management in accordance with examples as disclosed herein.

FIG. 5 shows a flowchart illustrating a method or methods that support techniques for changelog management in accordance with examples as disclosed herein.

### DETAILED DESCRIPTION

Some memory systems may implement changelogs associated with storing mappings of logical block addresses and physical block addresses of the memory systems (e.g., of a non-volatile memory of a memory system). For example, a memory system may store a new mapping (e.g., an updated mapping) within changelogs for one or more new access commands received from a host system. The memory system may implement the changelogs within a volatile memory, and the memory system may update information (e.g., a mapping table) stored at the volatile memory with the new mappings from the changelogs. In some cases, the memory system may update information (e.g., a mapping table) stored at a non-volatile memory by flushing the information (e.g., a mapping table) stored at the volatile memory.

In some cases, a bandwidth of the memory system may be improved, such that the memory system may support a relatively higher throughput of access commands. In some such cases, the changelogs of the memory system may reach capacity faster, such that the changelogs may not support the increased quantity of mappings associated with the relatively higher throughput. In some other different examples, a size of the changelogs may be increased to support the relatively higher throughput. However, increasing the size of the changelogs may be relatively expensive or spatially challenging to implement (e.g., challenging to implement without increasing a size of the memory system, which is relatively expensive). In other different examples, the memory system may not support the relatively higher throughput, and the memory system may pause or delay continuous host access operations. Accordingly, a memory system configured to support a relatively higher throughput without increasing the size of the changelogs may be desirable.

A memory system configured to support a relatively higher throughput (e.g., compared to previous implementations) without increasing the size of the changelogs is described herein. In accordance with examples as described herein, the memory system may support concurrent changelog management operations associated with performing host access operations, such as continuous host access operations, without pausing or delaying. For example, the memory system may implement a foreground changelog associated with storing new mappings received from a host system and a background changelog associated with storing old mappings received from the foreground changelog. The memory system may be configured to transfer old mappings (e.g., dummy mappings) from the background changelog to information, such as a mapping table, stored at a volatile memory of the memory system, while new mappings are received at the foreground changelog. Then, the memory system may transfer the new mappings from the foreground changelog to the background changelog (e.g., based on satisfying a capacity of the foreground changelog). The memory system may update information, such as the mapping table, with the old mappings each time the background changelog is emptied, and may flush information, such as the mapping table, to a non-volatile memory (e.g., a mapping table stored at the non-volatile memory) of the memory system other times the background changelog is emptied. Implementing the concurrent changelog management operations as described herein may support relatively higher throughput of the memory system without increasing the size of the changelogs, among other advantages.

In addition to applicability in memory systems as described herein, techniques for changelog management may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by supporting relatively higher throughput (e.g., compared to previous implementations), which may decrease processing or latency times, improve response times, or otherwise improve user experience, among other benefits.

Features of the disclosure are illustrated and described in the context of systems, devices, and circuits. Features of the disclosure are further illustrated and described in the context of processes and flowcharts.

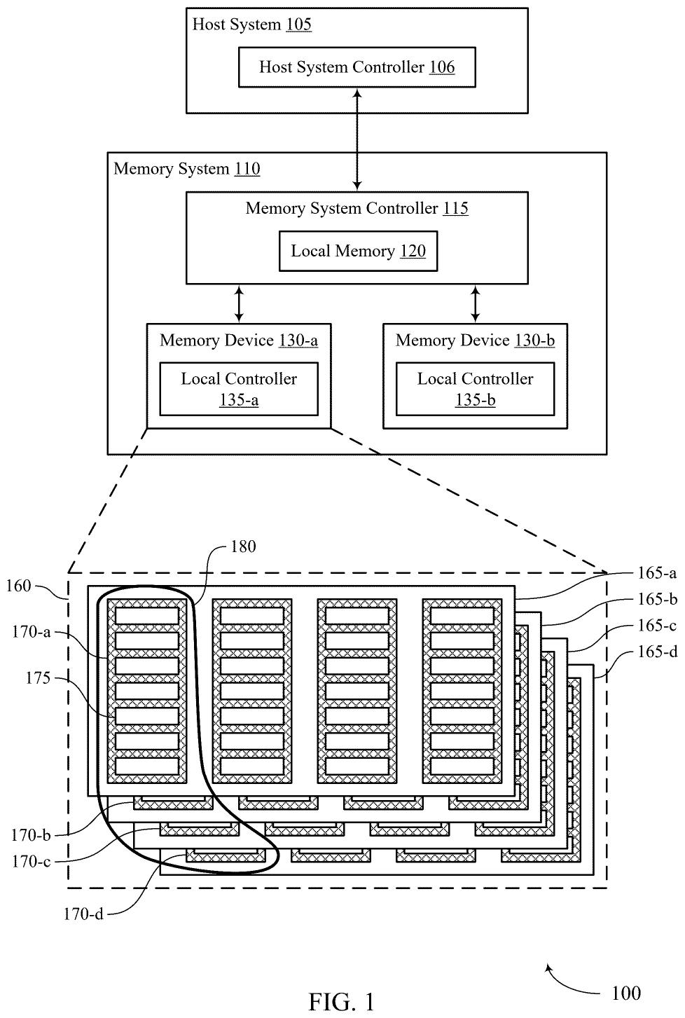

FIG. 1 shows an example of a system 100 that supports techniques for changelog management in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has not been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In accordance with examples as described herein, the memory system 110 may support concurrent changelog management operations associated with performing continuous host access operations without pause. For example, the memory system 110 may implement a foreground changelog associated with storing new mappings (e.g., mappings between logical addresses and physical addresses of the memory system 110) received from the host system 105 and a background changelog associated with storing old mappings received from the foreground changelog. The memory system 110 may be configured to transfer old mappings (e.g., or dummy mappings) from the background changelog to a mapping table (e.g., an L2P table) stored at a volatile memory (e.g., the local memory 120) of the memory system 110, while new mappings are received at the foreground changelog. Then, the memory system 110 may transfer the new mappings from the foreground changelog to the background changelog (e.g., based on satisfying a capacity of the foreground changelog). The memory system 110 may update the mapping table with the old mappings each time the background changelog is emptied, and may flush the mapping table to a mapping table stored at a non-volatile memory (e.g., the memory device 130-a) of the memory system 110 other times the background changelog is emptied. Implementing the concurrent changelog management operations as described herein may support relatively higher throughput of the memory system 110 without increasing the size of the changelogs.

The system 100 may include any quantity of non-transitory computer readable media that support techniques for changelog management. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

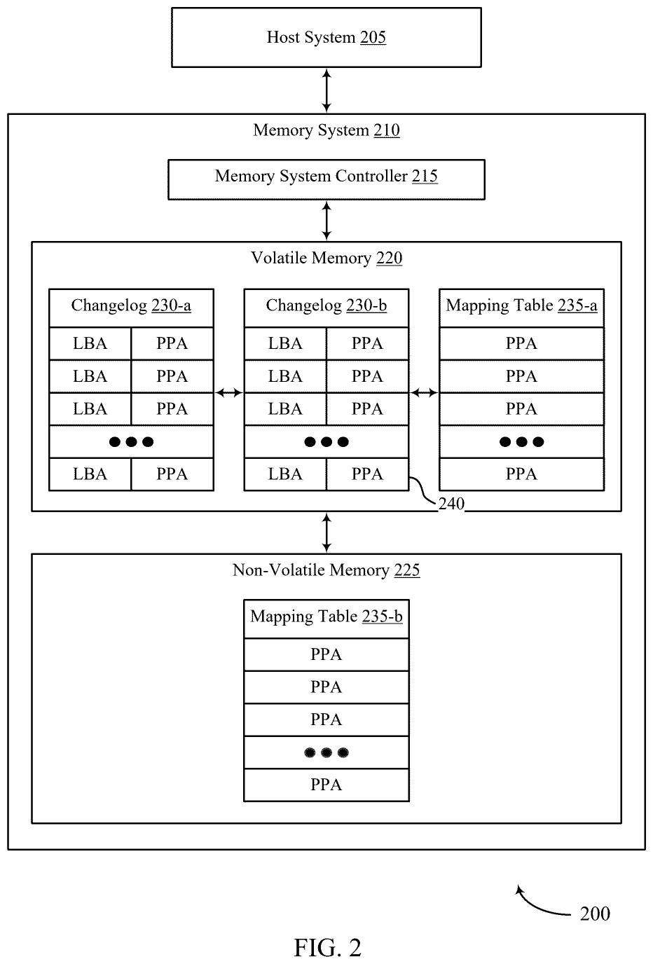

FIG. 2 shows an example of a system 200 that supports techniques for changelog management in accordance with examples as disclosed herein. The system 200 may implement aspects or operations of a system, which may be an example of a system 100, as described with reference to FIG. 1. For example, the system 200 may include a host system 205 and a memory system 210, which may be examples of a host system 105 and a memory system 110, respectively, as described with reference to FIG. 1. The memory system 210 may support relatively high throughput by implementing concurrent changelog management operations associated with enabling continuous host access operations (e.g., without pause).

The host system 205 may be coupled with the memory system 210, and configured to communicate with the memory system 210. For example, the host system 205 may be configured to transmit access commands to the memory system 210 and the memory system 210 may be configured to perform access operations corresponding to the access commands. The memory system 210 may include a memory system controller 215, which may be an example of a memory system controller 115 as described with reference to FIG. 1. The memory system controller 215 may be configured to facilitate operations of the memory system 210, such that the memory system controller 215 may receive access commands from the host system 205 (e.g., a host system controller) and perform access operations in accordance with the access commands.

The memory system 210 may include a volatile memory 220 and a non-volatile memory 225. The volatile memory 220 and the non-volatile memory 225 may each be coupled with the memory system controller 215, such that the memory system controller 215 may facilitate operations of the volatile memory 220 and the non-volatile memory 225. In some cases, the volatile memory 220 may be an SRAM array, a cache, or a local memory. For example, the volatile memory 220 may be a local memory (e.g., a local memory 120, as described with reference to FIG. 1) of the memory system controller 215. In some cases, the non-volatile memory 225 may be an example of a memory device 130, as described with reference to FIG. 1. For example, the non-volatile memory 225 may be a NAND memory array of the memory device 130, and the non-volatile memory 225 may include a quantity of NAND memory cells.

The volatile memory 220 may include a changelog 230-a and a changelog 230-b. The changelogs 230 may each be configured to store mappings between logical addresses of the non-volatile memory 225 and physical addresses of the non-volatile memory 225. For example, the changelogs 230 may include entries 240 each corresponding to a mapping between a logical address and a physical address of the non-volatile memory 225. In some cases, the logical addresses may be logical block addresses and the physical addresses may be physical page addresses. The changelog 230-a may be an example of a foreground changelog, such that the changelog 230-a may be configured to store new entries 240 received from the host system 205. For example, a host write command may indicate a mapping between a logical address and a physical address, and an entry 240 associated with the mapping may be stored in the changelog 230-a. The changelog 230-b may be an example of a background changelog, such that the changelog 230-b may be configured to store the entries 240 transferred from the changelog 230-a. For example, the memory system controller 215 may transfer the entries 240 (e.g., older entries) from the changelog 230-a to the changelog 230-b to support storing new entries 240 received from the host system 205 at the changelog 230-a. In some examples, the memory system controller 215 may transfer the entries 240 from the changelog 230-a to the changelog 230-b based on a capacity of the changelog 230-a being satisfied.

The volatile memory 220 and the non-volatile memory 225 may each include a mapping table 235, which may be an example of an L2P mapping table. For example, the volatile memory 220 may be configured to store a mapping table 235-a and the non-volatile memory 225 may be configured to store a mapping table 235-b. In some such examples, the mapping table 235-a (e.g., a physical page table (PPT)) may be a portion of the mapping table 235-b (e.g., an L2P table). That is, the mapping table 235-a may be stored in the volatile memory 220 because the volatile memory 220 may support relatively faster (e.g., lower latency) access operations than the non-volatile memory 225. Each mapping table 235 may include physical addresses of the non-volatile memory 225. For example, each mapping table 235 may be sorted (e.g., numerically sorted) based on logical addresses associated with the physical addresses of the non-volatile memory 225, such that the mapping tables 235 may not include logical addresses (e.g., the logical addresses are assumed based on the sorting of the mapping tables 235). Instead, each mapping table 235 may be associated with an initial logical address (e.g., a region number), such that a logical address associated with a physical address may be identified based on the mapping tables 235 being implicitly sorted based on the logical addresses. Further, each mapping table 235 may include the entries 240 for each physical address.

In some cases, the mapping table 235-a may be updated with the entries from the changelog 230-b. For example, the memory system controller 215 may transfer the entries 240 (e.g., older entries) from the changelog 230-b to the mapping table 235-a to support storing new entries 240 received from the changelog 230-a at the changelog 230-b. In some examples, the memory system controller 215 may transfer the entries 240 from the changelog 230-b to the mapping table 235-a based on a threshold associated with the changelog 230-a being satisfied. In some cases, transferring the entries 240 from the changelog 230-b to the mapping table 235-a may include updating and/or merging the entries 240 stored in the mapping table 235-a with the entries 240 received from the changelog 230-b. In some examples, the mapping table 235-a may be updated each time the entries 240 are transferred from the changelog 230-a to the mapping table 235-a.

In some cases, the mapping table 235-b may be updated with the entries from the mapping table 235-a. For example, the memory system controller 215 may transfer the entries 240 from the mapping table 235-a to the mapping table 235-b to support storing new entries 240 received from the changelog 230-b at the mapping table 235-a. In some examples, the memory system controller 215 may transfer the entries 240 from the mapping table 235-a to the mapping table 235-b based on a capacity associated with the mapping table 235-a being satisfied. In some examples, the memory system controller 215 may transfer the entries 240 from the mapping table 235-a to the mapping table 235-b other times the entries 240 are transferred from the changelog 230-b to the mapping table 235-a. In some cases, transferring the entries 240 from the mapping table 235-a to the mapping table 235-b may include updating and/or merging the entries 240 stored in the mapping table 235-b with the entries 240 received from the mapping table 235-a. In some examples, transferring the entries 240 from the mapping table 235-a to the mapping table 235-b may include flushing the mapping table 235-a, such that the mapping table 235-a may be emptied as a result of transferring the entries 240.

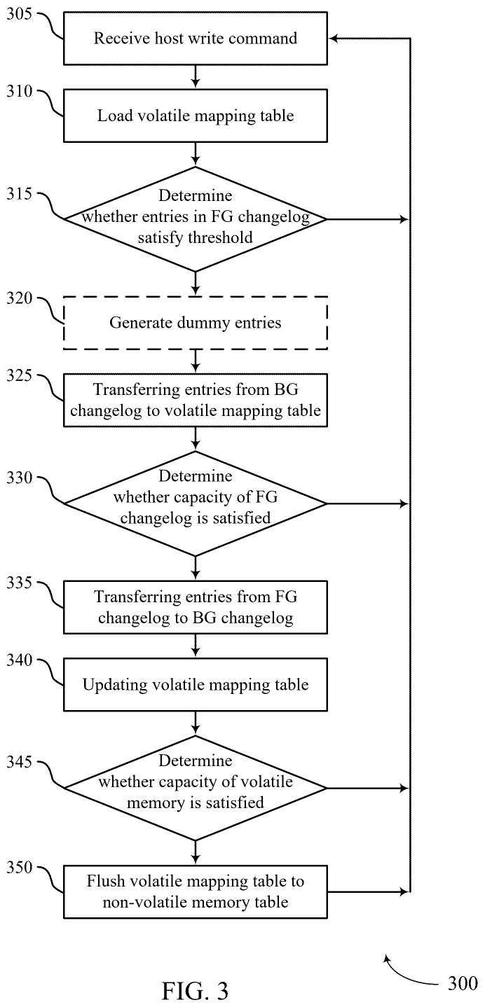

FIG. 3 shows an example of a process 300 that supports techniques for changelog management in accordance with examples as disclosed herein. The process 300 may implement aspects or operations of a system, which may be an example of a system 200, as described with reference to FIG. 2. For example, the process 300 may be implemented by a memory system, which may be an example of a memory system 210. In some cases, the process 300 may be facilitated by a memory system controller, which may be an example of a memory system controller 215. The process 300 may illustrate concurrent changelog management operations associated with enabling continuous host access operations for supporting improved throughput of the memory system.

In the following description of the process 300, the methods, techniques, processes, and operations may be performed in different orders or at different times. Further, some operations may be left out of the process 300, or other operations may be added to the process 300. Aspects of the process 300 may be implemented by one or more controllers, among other components. Additionally, or alternatively, aspects of the process 300 may be implemented as instructions stored in one or more memories (e.g., volatile memory, non-volatile memory). For example, the instructions, when executed by one or more controllers (e.g., the memory system controller 215), may cause the one or more controllers (or a device or a system) to perform the operations of the process 300.

At 305, a host write command may be received. For example, the memory system controller may receive the host write command from a host system (e.g., a host system 205) coupled with the memory system. The host write command may include data to be written to a non-volatile memory of the memory system, which may be an example of a non-volatile memory 225. The host write command may include an indication of a logical address associated with a physical address of the non-volatile memory, at which the data may be stored. For example, the host write command may include a mapping between a logical address (e.g., a logical block address) of the non-volatile memory and a physical address (e.g., a physical page address) of the non-volatile memory.

The mapping may be stored to a foreground changelog of the memory system, which may be an example of a changelog 230-a. For example, the mapping may be stored in the foreground changelog as an entry including an indication of the logical address and the physical address. In some examples, the foreground changelog may be stored within a volatile memory of the memory system, such as an SRAM array implemented as a local memory of the memory system controller. In some such examples, the memory system controller may store the entry to the foreground changelog. In some implementations, the foreground changelog may be organized according to a first-in first-out (FIFO) pattern, such that the entries may be organized based on program recency. For example, a most recently stored entry may be stored in a position of the foreground changelog opposite to a position of the least recently stored entry. In some such implementations, the memory system controller may store the entry in the position associated with the most recently stored entry.

In some cases, the entry may be stored to the foreground changelog based on determining whether a capacity of the foreground changelog has been satisfied (e.g., determining that a capacity of the foreground changelog has not been satisfied). For example, the foreground changelog may be configured to store a quantity of entries based on a capacity of the foreground changelog. Thus, the entry may be stored to the foreground changelog if the entry will not exceed the quantity of entries associated with the capacity of the foreground changelog. However, if the memory system controller determines that the entry will cause the quantity of entries to exceed the capacity of the foreground changelog, the memory system controller may store the host write command in a command queue until the quantity of entries do not satisfy the capacity of the foreground changelog and the entry may be stored to the foreground changelog. In some cases, the entry may be stored to the foreground changelog based on determining that the entry is associated with a new mapping. For example, the entry may be associated with a logical address and a physical address that have not been stored as an entry in the foreground changelog. However, if the memory system controller determines that the entry is associated with a mapping already stored in the foreground changelog, the entry may not be stored to the foreground changelog.

At 310, a volatile mapping table may be loaded into the volatile memory. The volatile mapping table may be an example of a mapping table 235-a. The volatile mapping table may be an example of an L2P table stored within the volatile memory and may be configured to store mappings as entries each including an indication of a physical address of the non-volatile memory. In some examples, the physical address may be associated with a logical address based on an initial logical address of the volatile memory and a sorting of the volatile memory. In some examples, the volatile mapping table may be a portion of a non-volatile mapping table stored within the non-volatile memory. For example, the memory system controller may load the volatile mapping table from the non-volatile memory to the volatile memory based on transferring a portion of a non-volatile mapping table to the volatile memory.

At 315, the memory system controller may determine whether the quantity of entries in the foreground changelog satisfies a threshold. The threshold may be associated with a quantity of entries or a quantity of free slots (e.g., each for storing an entry) in the foreground changelog. In some examples, the threshold may be associated with a percentage of the capacity of the foreground changelog, such as 50% of the capacity. The memory system controller may determine whether the quantity of entries in the foreground changelog satisfies the threshold based on storing the entry to the foreground changelog at operation 305 of the process 300. For example, storing the entry to the foreground changelog may increase the quantity of entries in the foreground changelog, such that the memory system controller may determine whether the increased quantity of entries satisfies the threshold. The memory system controller may determine whether the quantity of entries in the foreground changelog satisfies the threshold after storing each new entry to the foreground changelog.

In some cases, the memory system controller may determine the quantity of entries in the foreground changelog satisfy the threshold, and the process 300 may continue to operation 320. For example, the memory system controller may determine the quantity of entries satisfies the threshold or the quantity of free slots satisfies the threshold. In other cases, the memory system controller may determine the quantity of entries in the foreground changelog do not satisfy the threshold, and the process 300 may continue back to operation 305, where the memory system controller may receive another host write command and another entry may be stored to the foreground changelog.

At 320, dummy entries may be generated. In some cases, the memory system controller may generate dummy entries, which may each include a dummy mapping between a dummy logical address (e.g., a blank logical address) and a dummy physical address (e.g., a blank physical address). The memory system may include a background changelog, which may be an example of a changelog 230-b. The background changelog may be stored within the volatile memory and may be configured to store mappings as entries each including an indication of a logical address and a physical address of the non-volatile memory. In some cases, the dummy entries may be generated based on determining a quantity of entries in the background changelog do not satisfy a threshold. For example, the memory system controller may determine the background changelog is empty and the memory system controller may generate the dummy entries. In some cases, the dummy entries may be generated based on determining whether a capacity of a volatile mapping table is satisfied. For example, the memory system controller may determine the capacity of the volatile mapping table is not satisfied and the memory system controller may generate the dummy entries.

At 325, entries from the background changelog may be transferred to the volatile mapping table. For example, the memory system controller may transfer the entries of the background changelog to the volatile mapping table. In some cases, the memory system controller may transfer the entries of the background changelog to the volatile mapping table based on determining the quantity of entries in the foreground changelog satisfied the threshold.

In some examples, transferring the entries of the background changelog to the volatile mapping table may include transferring each entry stored in the background changelog to the volatile mapping table, or transferring a quantity of entries stored in the background changelog to the volatile mapping table. In some implementations, the background changelog may include entries transferred from the foreground changelog, such that transferring the entries from the background changelog to the volatile mapping table may include transferring the entries that were received from the foreground changelog. In other implementations, the quantity of entries in the background changelog may not satisfy a threshold, such that transferring the entries from the background changelog to the volatile mapping table may include storing the dummy entries in the volatile mapping table. In some such implementations, the dummy entries may be stored to the volatile mapping table based on determining the capacity of the volatile mapping table is not satisfied. In some cases, transferring the entries from the background changelog to the volatile mapping table may be concurrent with receiving additional host write commands, such that entries may be stored to the foreground changelog concurrently with transferring the entries.

At 330, the memory system controller may determine whether the capacity of the foreground changelog is satisfied. For example, during operations 320 and 325 of the process 300, the memory system controller may continue to receive additional host write commands. In some such examples, the foreground changelog may continue to store additional entries associated with the additional write commands. In some implementations, the additional entries may exceed the threshold described in operation 315 of the process 300. Thus, the memory system controller may determine whether the capacity of the foreground changelog is satisfied. The capacity of the foreground changelog may be a total quantity of entries the foreground changelog may be capable of storing. In some cases, the memory system controller may determine that the quantity of entries in the foreground changelog has satisfied the capacity of the foreground changelog, and the process 300 may continue to operation 335. In other cases, the memory system controller may determine that the quantity of entries in the foreground changelog has not satisfied the capacity of the foreground changelog, and the process 300 may continue back to operation 305, such that the foreground changelog may receive additional entries.

At 335, the entries stored in the foreground changelog may be transferred to the background changelog. The memory system controller may transfer the entries from the foreground changelog to the background changelog. In some cases, the memory system controller may transfer the entries based on determining that the quantity of entries in the foreground changelog satisfies the capacity of the foreground changelog. In some cases, the memory system controller may transfer the entries based on transferring the stored in the background changelog to the volatile mapping table, such that the background changelog may support storing the entries received from the foreground changelog. In some cases, the entries may be sorted within the background changelog based on transferring the entries from the foreground changelog. For example, the memory system may sort the entries during transferring the entries from the foreground changelog to the background changelog. The entries may be sorted based on a numerical order of the entries. That is, the entries may be organized according to the numerical order of the logical addresses associated with the entries, such that the logical addresses may be in an ascending or descending order and the entries may be correspondingly sorted. In some examples, the foreground changelog may receive new entries concurrently with transferring the entries to the background changelog. That is, the memory system controller may continue to receive host write commands and corresponding entries may be stored to the foreground changelog while the entries are transferred to the background changelog.

At 340, the volatile mapping table may be updated. The memory system controller may update the volatile mapping table with the entries transferred from the background changelog. In some examples, the memory system controller may update the volatile mapping table based on transferring the entries from the foreground changelog to the background changelog. In some cases, updating the volatile mapping table may include adding the entries transferred from the background changelog to the entries stored in the volatile mapping table. In some cases, updating the volatile mapping table may include identifying duplicate entries after adding the entries transferred from the background changelog and merging the entries within the volatile mapping table. In some cases, updating the volatile mapping table may include identifying entries associated with a same logical addresses and updating the entries with the corresponding physical address transferred as part of the entries received from the background changelog. In some examples, the foreground changelog may receive new entries concurrently with updating the volatile mapping table. That is, the memory system controller may continue to receive host write commands and corresponding entries may be stored to the foreground changelog while the volatile mapping table is being updated.

At 345, the memory system controller may determine whether a capacity of the volatile mapping table is satisfied. For example, the memory system controller may determine whether the capacity of the volatile mapping table is satisfied based on updating the volatile mapping table at operation 340 of the process 300. The capacity of the volatile mapping table may be a total quantity of entries the volatile mapping table may be capable of storing. In some cases, the memory system controller may determine that the quantity of entries in the volatile mapping table has satisfied the capacity of the volatile mapping table, and the process 300 may continue to operation 350. In other cases, the memory system controller may determine that the quantity of entries in the volatile mapping table has not satisfied the capacity of the volatile mapping table, and the process 300 may continue back to operation 305, such that the foreground changelog may receive additional entries.

At 350, the volatile mapping table may be flushed to the non-volatile mapping table. For example, the memory system controller may transfer the entries from the volatile mapping table to the non-volatile mapping table. In some examples, the volatile mapping table may be emptied as a result of transferring the entries from the volatile mapping table. The memory system controller may update the non-volatile mapping table with the entries transferred from the volatile mapping table. In some examples, the memory system controller may update the non-volatile mapping table based on transferring the entries from the volatile mapping table to the non-volatile mapping table. In some cases, updating the non-volatile mapping table may include adding the entries transferred from the volatile mapping table to the entries stored in the non-volatile mapping table. In some cases, updating the non-volatile mapping table may include identifying duplicate entries after adding the entries transferred from the volatile mapping table and merging the entries within the non-volatile mapping table. In some cases, updating the non-volatile mapping table may include identifying entries associated with a same logical addresses and updating the entries with the corresponding physical address transferred as part of the entries received from the volatile mapping table. In some cases, flushing the volatile mapping table may include flushing other mapping tables (e.g., PPT, PPT2, cache memory, buffer table, system mapping table) of the memory system.

In some cases, the volatile mapping table may be flushed to the non-volatile mapping table based on the memory system controller determining that the quantity of entries in the volatile mapping table has satisfied the capacity of the volatile mapping table. In some such cases, the capacity of the volatile mapping table may be twice the capacity of the background changelog, such that the volatile mapping table may be flushed every other time that the background changelog is emptied. That is, the volatile mapping table may be flushed every other time the volatile mapping table is updated. Concurrently with flushing the volatile mapping table, the process 300 may return to operation 305, such that the foreground changelog may receive new entries concurrently with flushing the volatile mapping table. In some cases, the operations 305 through 340 may of a next cycle through the process 300 may be performed concurrently with flushing the volatile mapping table to the non-volatile mapping table.

Implementing the process 300 may support relatively high throughput of the memory system without increasing a size of the changelogs. Because the changelogs may be configured to transfer entries concurrently with receiving host write commands, the memory system may not pause the corresponding write operations from occurring, which may improve throughput of the memory system.

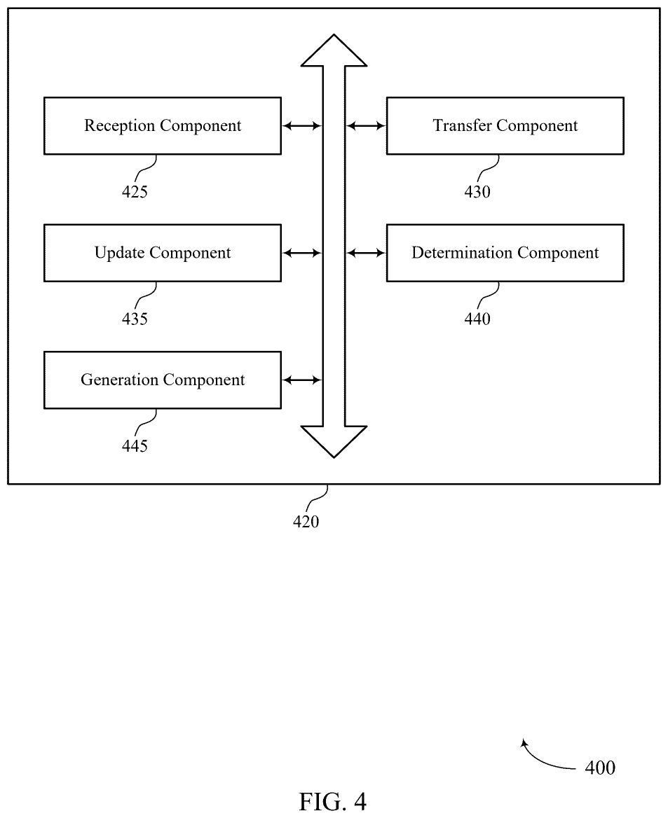

FIG. 4 shows a block diagram 400 of a memory system 420 that supports techniques for changelog management in accordance with examples as disclosed herein. The memory system 420 may be an example of aspects of a memory system as described with reference to FIGS. 1 through 3. The memory system 420, or various components thereof, may be an example of means for performing various aspects of techniques for changelog management as described herein. For example, the memory system 420 may include a reception component 425, a transfer component 430, an update component 435, a determination component 440, a generation component 445, or any combination thereof. Each of these components, or components of subcomponents thereof (e.g., one or more processors, one or more memories), may communicate, directly or indirectly, with one another (e.g., via one or more buses).

The reception component 425 may be configured as or otherwise support a means for receiving a plurality of first entries at a first changelog, each entry associated with a mapping between a logical address of a non-volatile memory and a physical address of the non-volatile memory. The transfer component 430 may be configured as or otherwise support a means for transferring, concurrently with receiving one or more first entries of the plurality of first entries, a plurality of second entries from a second changelog to a mapping stored at a volatile memory in response to the plurality of first entries satisfying a threshold quantity of entries. In some examples, the transfer component 430 may be configured as or otherwise support a means for transferring the plurality of first entries from the first changelog to the second changelog in accordance with transferring the plurality of second entries.

In some examples, the update component 435 may be configured as or otherwise support a means for updating the mapping stored at the volatile memory in response to transferring the plurality of second entries.

In some examples, the transfer component 430 may be configured as or otherwise support a means for transferring the updated mapping to the non-volatile memory. In some examples, the update component 435 may be configured as or otherwise support a means for updating a second mapping stored at the non-volatile memory in accordance with the updated mapping.

In some examples, the determination component 440 may be configured as or otherwise support a means for determining whether a capacity of the volatile memory associated with storing the mapping has been satisfied, where transferring the updated mapping to the non-volatile memory is in response to determining that the capacity of the volatile memory has been satisfied.

In some examples, transferring the updated mapping to the non-volatile memory is concurrent with receiving a plurality of third entries at the first changelog.

In some examples, the determination component 440 may be configured as or otherwise support a means for determining whether a capacity of the first changelog has been satisfied in response to receiving the plurality of first entries, where transferring the plurality of first entries from the first changelog to the second changelog is in response to determining that the capacity of the first changelog has been satisfied.

In some examples, the generation component 445 may be configured as or otherwise support a means for generating one or more dummy entries, where transferring the plurality of second entries includes transferring the one or more dummy entries to the mapping.

In some examples, the determination component 440 may be configured as or otherwise support a means for determining whether the second changelog includes a quantity of entries in response to the first changelog receiving the plurality of first entries, where generating the one or more dummy entries is in response to determining the second changelog does not include the quantity of entries.

In some examples, the generation component 445 may be configured as or otherwise support a means for determining whether a capacity of the volatile memory associated with storing the mapping has been satisfied, where generating the one or more dummy entries is in response to determining that the capacity of the volatile memory has been satisfied.

In some examples, the threshold quantity of entries is associated with a capacity of the first changelog.

In some examples, the first changelog is a foreground changelog and the second changelog is a background changelog.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

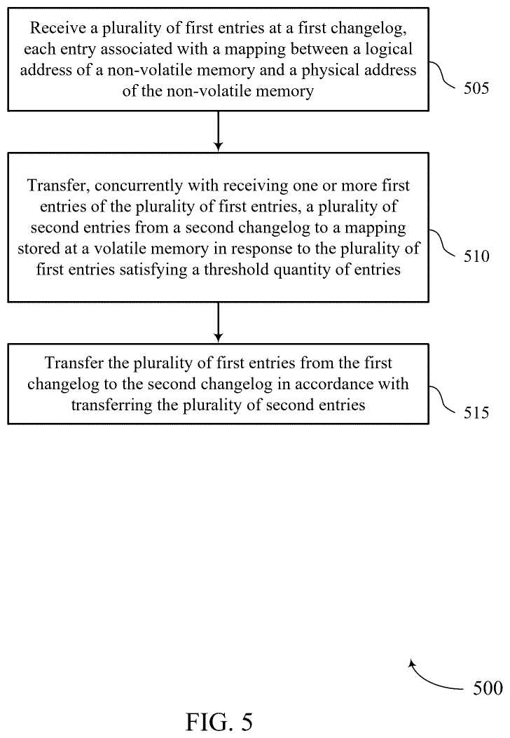

FIG. 5 shows a flowchart illustrating a method 500 that supports techniques for changelog management in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving a plurality of first entries at a first changelog, each entry associated with a mapping between a logical address of a non-volatile memory and a physical address of the non-volatile memory. In some examples, aspects of the operations of 505 may be performed by a reception component 425 as described with reference to FIG. 4.

At 510, the method may include transferring, concurrently with receiving one or more first entries of the plurality of first entries, a plurality of second entries from a second changelog to a mapping stored at a volatile memory in response to the plurality of first entries satisfying a threshold quantity of entries. In some examples, aspects of the operations of 510 may be performed by a transfer component 430 as described with reference to FIG. 4.

At 515, the method may include transferring the plurality of first entries from the first changelog to the second changelog in accordance with transferring the plurality of second entries. In some examples, aspects of the operations of 515 may be performed by a transfer component 430 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for receiving a plurality of first entries at a first changelog, each entry associated with a mapping between a logical address of a non-volatile memory and a physical address of the non-volatile memory; transferring, concurrently with receiving one or more first entries of the plurality of first entries, a plurality of second entries from a second changelog to a mapping stored at a volatile memory in response to the plurality of first entries satisfying a threshold quantity of entries; and transferring the plurality of first entries from the first changelog to the second changelog in accordance with transferring the plurality of second entries.
Aspect 2: The method, apparatus, or non-transitory computer-readable medium of aspect 1, further including operations, features, circuitry, logic, means, or instructions, or any combination thereof for updating the mapping stored at the volatile memory in response to transferring the plurality of second entries.
Aspect 3: The method, apparatus, or non-transitory computer-readable medium of aspect 2, further including operations, features, circuitry, logic, means, or instructions, or any combination thereof for transferring the updated mapping to the non-volatile memory and updating a second mapping stored at the non-volatile memory in accordance with the updated mapping.
Aspect 4: The method, apparatus, or non-transitory computer-readable medium of aspect 3, further including operations, features, circuitry, logic, means, or instructions, or any combination thereof for determining whether a capacity of the volatile memory associated with storing the mapping has been satisfied, where transferring the updated mapping to the non-volatile memory is in response to determining that the capacity of the volatile memory has been satisfied.
Aspect 5: The method, apparatus, or non-transitory computer-readable medium of any of aspects 3 through 4, where transferring the updated mapping to the non-volatile memory is concurrent with receiving a plurality of third entries at the first changelog.
Aspect 6: The method, apparatus, or non-transitory computer-readable medium of any of aspects 1 through 5, further including operations, features, circuitry, logic, means, or instructions, or any combination thereof for determining whether a capacity of the first changelog has been satisfied in response to receiving the plurality of first entries, where transferring the plurality of first entries from the first changelog to the second changelog is in response to determining that the capacity of the first changelog has been satisfied.
Aspect 7: The method, apparatus, or non-transitory computer-readable medium of any of aspects 1 through 6, further including operations, features, circuitry, logic, means, or instructions, or any combination thereof for generating one or more dummy entries, where transferring the plurality of second entries includes transferring the one or more dummy entries to the mapping.
Aspect 8: The method, apparatus, or non-transitory computer-readable medium of aspect 7, further including operations, features, circuitry, logic, means, or instructions, or any combination thereof for determining whether the second changelog includes a quantity of entries in response to the first changelog receiving the plurality of first entries, where generating the one or more dummy entries is in response to determining the second changelog does not include the quantity of entries.
Aspect 9: The method, apparatus, or non-transitory computer-readable medium of any of aspects 7 through 8, further including operations, features, circuitry, logic, means, or instructions, or any combination thereof for determining whether a capacity of the volatile memory associated with storing the mapping has been satisfied, where generating the one or more dummy entries is in response to determining that the capacity of the volatile memory has been satisfied.
Aspect 10: The method, apparatus, or non-transitory computer-readable medium of any of aspects 1 through 9, where the threshold quantity of entries is associated with a capacity of the first changelog.
Aspect 11: The method, apparatus, or non-transitory computer-readable medium of any of aspects 1 through 10, where the first changelog is a foreground changelog and the second changelog is a background changelog.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a plurality of first entries at a first changelog, each entry associated with a mapping between a logical address of a non-volatile memory and a physical address of the non-volatile memory;
transfer, concurrently with receiving one or more first entries of the plurality of first entries, a plurality of second entries from a second changelog to a mapping stored at a volatile memory in response to the plurality of first entries satisfying a threshold quantity of entries; and
transfer the plurality of first entries from the first changelog to the second changelog in accordance with transferring the plurality of second entries.

2. The memory system of claim 1, wherein the processing circuitry is further configured to cause the memory system to:
update the mapping stored at the volatile memory in response to transferring the plurality of second entries.

3. The memory system of claim 2, wherein the processing circuitry is further configured to cause the memory system to:
transfer the updated mapping to the non-volatile memory; and
update a second mapping stored at the non-volatile memory in accordance with the updated mapping.

4. The memory system of claim 3, wherein the processing circuitry is further configured to cause the memory system to:
determine whether a capacity of the volatile memory associated with storing the mapping has been satisfied, wherein transferring the updated mapping to the non-volatile memory is in response to determining that the capacity of the volatile memory has been satisfied.

5. The memory system of claim 3, wherein transferring the updated mapping to the non-volatile memory is concurrent with receiving a plurality of third entries at the first changelog.

6. The memory system of claim 1, wherein the processing circuitry is further configured to cause the memory system to:
determine whether a capacity of the first changelog has been satisfied in response to receiving the plurality of first entries,
wherein transferring the plurality of first entries from the first changelog to the second changelog is in response to determining that the capacity of the first changelog has been satisfied.

7. The memory system of claim 1, wherein the processing circuitry is further configured to cause the memory system to:
generate one or more dummy entries, wherein transferring the plurality of second entries comprises transferring the one or more dummy entries to the mapping.

8. The memory system of claim 7, wherein the processing circuitry is further configured to cause the memory system to:
determine whether the second changelog comprises a quantity of entries in response to the first changelog receiving the plurality of first entries,
wherein generating the one or more dummy entries is in response to determining the second changelog does not comprise the quantity of entries.

9. The memory system of claim 7, wherein the processing circuitry is further configured to cause the memory system to:
determine whether a capacity of the volatile memory associated with storing the mapping has been satisfied,
wherein generating the one or more dummy entries is in response to determining that the capacity of the volatile memory has been satisfied.

10. The memory system of claim 1, wherein the threshold quantity of entries is associated with a capacity of the first changelog.

11. The memory system of claim 1, wherein the first changelog is a foreground changelog and the second changelog is a background changelog.

12. A non-transitory computer-readable medium storing code, the code comprising instructions executable by one or more processors to:
receive a plurality of first entries at a first changelog, each entry associated with a mapping between a logical address of a non-volatile memory and a physical address of the non-volatile memory;
transfer, concurrently with receiving one or more first entries of the plurality of first entries, a plurality of second entries from a second changelog to a mapping stored at a volatile memory in response to the plurality of first entries satisfying a threshold quantity of entries; and
transfer the plurality of first entries from the first changelog to the second changelog in accordance with transferring the plurality of second entries.

13. The non-transitory computer-readable medium of claim 12, wherein the instructions are further executable by the one or more processors to:
update the mapping stored at the volatile memory in response to transferring the plurality of second entries.

14. The non-transitory computer-readable medium of claim 13, wherein the instructions are further executable by the one or more processors to:
transfer the updated mapping to the non-volatile memory; and
update a second mapping stored at the non-volatile memory in accordance with the updated mapping.

15. The non-transitory computer-readable medium of claim 14, wherein the instructions are further executable by the one or more processors to:
determine whether a capacity of the volatile memory associated with storing the mapping has been satisfied,
wherein transferring the updated mapping to the non-volatile memory is in response to determining that the capacity of the volatile memory has been satisfied.

16. The non-transitory computer-readable medium of claim 12, wherein the instructions are further executable by the one or more processors to:
determine whether a capacity of the first changelog has been satisfied in response to receiving the plurality of first entries,
wherein transferring the plurality of first entries from the first changelog to the second changelog is in response to determining that the capacity of the first changelog has been satisfied.

17. The non-transitory computer-readable medium of claim 12, wherein the instructions are further executable by the one or more processors to:
generate one or more dummy entries,
wherein transferring the plurality of second entries comprises transferring the one or more dummy entries to the mapping.

18. The non-transitory computer-readable medium of claim 17, wherein the instructions are further executable by the one or more processors to:
determine whether the second changelog comprises a quantity of entries in response to the first changelog receiving the plurality of first entries,
wherein generating the one or more dummy entries is in response to determining the second changelog does not comprise the quantity of entries.

19. The non-transitory computer-readable medium of claim 17, wherein the instructions are further executable by the one or more processors to:
determine whether a capacity of the volatile memory associated with storing the mapping has been satisfied,
wherein generating the one or more dummy entries is in response to determining that the capacity of the volatile memory has been satisfied.

20. A method by a memory system, comprising:
receiving a plurality of first entries at a first changelog, each entry associated with a mapping between a logical address of a non-volatile memory and a physical address of the non-volatile memory;
transferring, concurrently with receiving one or more first entries of the plurality of first entries, a plurality of second entries from a second changelog to a mapping stored at a volatile memory in response to the plurality of first entries satisfying a threshold quantity of entries; and
transferring the plurality of first entries from the first changelog to the second changelog in accordance with transferring the plurality of second entries.

21. The method of claim 20, further comprising:
updating the mapping stored at the volatile memory in response to transferring the plurality of second entries.

22. The method of claim 21, further comprising:
transferring the updated mapping to the non-volatile memory; and
updating a second mapping stored at the non-volatile memory in accordance with the updated mapping.

23. The method of claim 22, further comprising:
determining whether a capacity of the volatile memory associated with storing the mapping has been satisfied,
wherein transferring the updated mapping to the non-volatile memory is in response to determining that the capacity of the volatile memory has been satisfied.

24. The method of claim 20, further comprising:
determining whether a capacity of the first changelog has been satisfied in response to receiving the plurality of first entries,
wherein transferring the plurality of first entries from the first changelog to the second changelog is in response to determining that the capacity of the first changelog has been satisfied.

25. The method of claim 20, further comprising:
generating one or more dummy entries,
wherein transferring the plurality of second entries comprises transferring the one or more dummy entries to the mapping.
